(19) United States
(12) Patent Application Publication
(10) Pub. No.: US 2010/0309168 A1
(43) Pub. Date: Dec. 9, 2010

(54) OPTICAL TOUCH SYSTEM

(75) Inventor: SHAN-FU HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/780,940

(22) Filed: May 17, 2010

(30) Foreign Application Priority Data
Jun. 5, 2009 (CN) 200910302958.5

(51) Int. Cl. G06F 3/042

(52) U.S. Cl. 345/175

(57) ABSTRACT

An optical touch system includes an infrared touch pen, a display panel, an image sensor, a time recorder, and a processor. The infrared touch pen is used for touching the display panel and can emit an infrared beam. The image sensor is configured to receive the infrared beam emitted by the infrared touch pen. The time recorder is configured for reordering a first time at which the infrared touch pen emits the infrared beam and a second time at which the image sensor receives the infrared emission. The processor connects with the image sensor and the time recorder and is configured for computing a distance between the touch of the infrared touch pen and the image sensor and the coordinates of the infrared touch pen.

### BACKGROUND

1. Technical Field

The present disclosure relates to a touch system, and particularly, to an optical touch system.

2. Description of Related Art

Touch systems are becoming more prevalent in everyday life. Conventional touch systems comprise resistor touch systems, capacitor touch systems, and surface acoustic wave (SAW) touch systems.

The resistor touch systems include a display panel and a resistor film set on the display panel. The resistor film includes a first conductive layer, a second conductive layer, and a number of spacers defined therebetween. When the display panel is touched, the first conductive layer and the second conductive layer contact each other, and then the resistance between the first conductive layer and the second conductive layer changes, and signals are generated along two directions. A controller receives the signals and the coordinates of the touched part of the display panel are calculated. Because water, dust, and dirt do not affect the performance of the resistor touch systems, the systems are suitable for use in many environments. However, the conductive layers are thin and do not age well with repeated use often deforming and developing cracks.

The capacitor touch systems have a thin film and a number of oscillators connected to the thin film. When an object, for example a finger, touches the thin film, a coupling capacitance is generated between the finger and the thin film. And then, the frequency of the oscillator connected to the touched portion changes. The coordinates of the point of the touched portion are obtained according the frequency. However, capacitance values can be affect by environmental conditions, such as temperature and humidity and so suffer from instability and drift.

The SAW touch system includes a panel, a SAW generator, a SAW receiver, and a controller. The SAW emitted by the SAW generator transmits along the panel toward the SAW receiver. When a finger touches the panel, it prevents a portion of the SAW from reaching the receiver and the coordinates of the touch can be determined by the controller. The SAW is not affected by temperature and humidity. The SAW touch systems have good resolution, are abrasion resistant, and are long lasting. However, the SAW touch systems are easily affected by any contaminants deposited on the panel such water, dust, and oil from users' skin, so that cleaning is often needed.

What is needed, therefore, is an optical touch system, which can overcome the above shortcomings.

### BRIEF DESCRIPTION OF THE DRAWINGS

Many aspects of the present optical touch system can be better understood with reference to the following drawings. The components in the drawings are not necessarily drawn to scale, the emphasis instead being placed upon clearly illustrating the principles of the present optical touch system. Moreover, in the drawings, like reference numerals designate corresponding parts throughout the several views.

FIG. 1 is a schematic view of a first embodiment of an optical touch system.

FIG. 2 is a schematic view of a second embodiment of an optical touch system.

### DETAILED DESCRIPTION

Embodiments of the present optical touch system will now be described in detail below and with reference to the drawings.

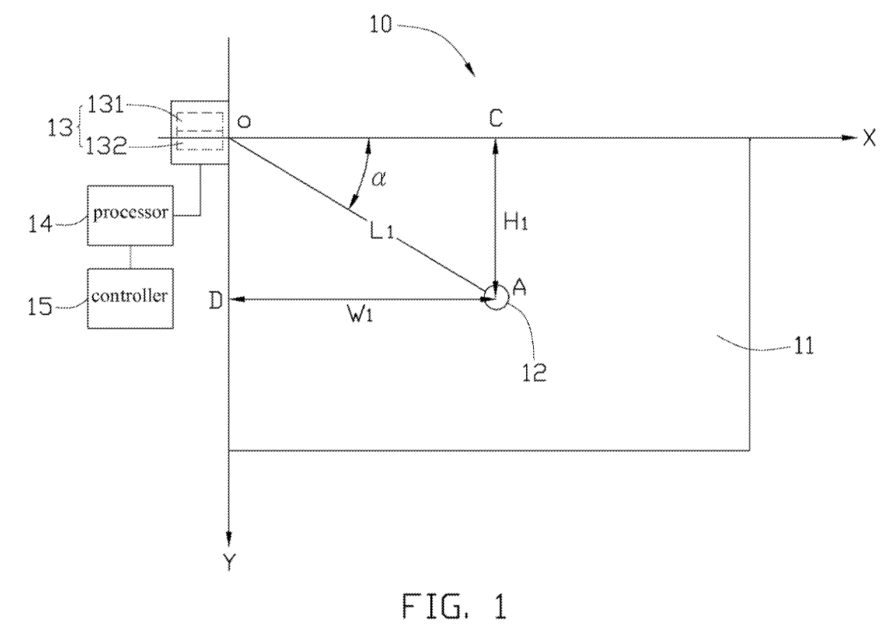

Referring to FIG. 1, a first embodiment of an optical touch system 10 is shown. The optical touch system 10 includes a display panel 11, an infrared (IR) touch pen 12, a time and image recorder 13, a processor 14, and a controller 15.

The IR touch pen 12 can be a conventional touch pen, and the IR touch pen 12 includes a pressure sensor and an illuminator. While the IR touch pen 12 touches the display panel 11, a pressure is generated between the IR touch pen 12 and the display panel 11. When the pressure sensor senses the pressure between the IR touch pen 12 and the display panel 11, the pressure sensor drives the illuminator to emit an IR beam. The illuminator may include a light-emitting diode (LED).

The display panel 11 is generally rectangular shaped. An XY coordinate system is used with the origin set as the top left corner of the display panel 11 as viewed in FIG. 1. The time and image recorder 13 is set on the origin (labeled O) of the X axis and the Y axis. The time and image recorder 13 captures images of the field of view that includes the panel 11 when the IR touch pen 12 starts to emit the IR beam and the time and image recorder 13 receives the IR beam and further, records the time of the IR emission.

The time and image recorder 13 includes a time recorder 131 and an image sensor 132. A first time is recorded by the time recorder 131 at the beginning of an IR emission event by the IR touch pen 12. A second time is recorded by the time recorder 131 when the image sensor 122 receives the IR emission of the same emission event.

The image sensor 132 may be a charge coupled device (CCD) or a complementary-metal oxide semiconductor (CMOS).

When the IR touch pen 12 touches the display panel 11, for example, at a point A. The image sensor 132 receives the IR beam emitted by the IR touch pen 12 and an image signal is formed by the image sensor 132. The time and image recorder 13 is connected with the controller 15 through the processor 14. The processor 14 receives the image signal from the time and image recorder 13 and computes an angle α formed by a line from the point A to the origin O and the X axis according to the image signal, and then outputs the angel α to the controller 15. The angle α reveals what direction along the touch panel 11 from the origin O that a touch by the IR pen has occurred.

When the IR touch pen 12 touches the display panel 11, the pressure sensor of the IR touch pen 12 senses a pressure between the IR touch pen 12 and the display panel 11, and then the pressure sensor drives the illuminator to emit an IR beam. The time recorder 131 of the time and image sensor 13 records the time t₁ at which the illuminator starts to emit the IR beam. Then the time recorder 131 records the time t₂ when the image sensor 132 receives the IR emission. t₂ minus t₁ gives the time elapsed t so that distance the touch occurred from the origin O can be calculated thus giving the coordinates of the touch. Once the coordinates of the touch are determined the controller 15 executes whatever command or commands are associated with a touch at those coordinates.

The following mathematically describes how the coordinates are determined. The processor 14 performs a calculation using a formula (1) as follows.

L₁=v×t (1)

wherein, L₁ is a distance of the point A from the time and image sensor 13 (origin), v is the light velocity, which is 3×10⁸ meters per second.

As shown in FIG. 1, a line AC marks the distance from the point A to the X axis. A line AD marks the distance from the point A to the Y axis. On the right triangles AOC and AOD, the processor 14 performs calculations using formulas (2) and (3) below.

H₁=L₁×Sin α (2)

W₁=L₁×Cos α (3)

The IR touch pen 12 and the time and image sensor 13 constitute the main portion of the optical touch system 10. The optical touch system 10 uses the time lapse between the first time at which the IR touch pen 12 emits the IR beam and the second time at which the image sensor 132 receives the IR emission to calculate the distance and direction of the touch point A in relation to the image sensor 132. The optical touch system 10 has a single structure and low lost. The IR emission is not easily affected by environmental conditions, abrasion, and contaminants and will age well, compared with the resistor touch systems, capacitor touch systems and the SAW touch systems. The optical touch system 10 achieves good light transmission and can be reliably used in many different conditions and environments.

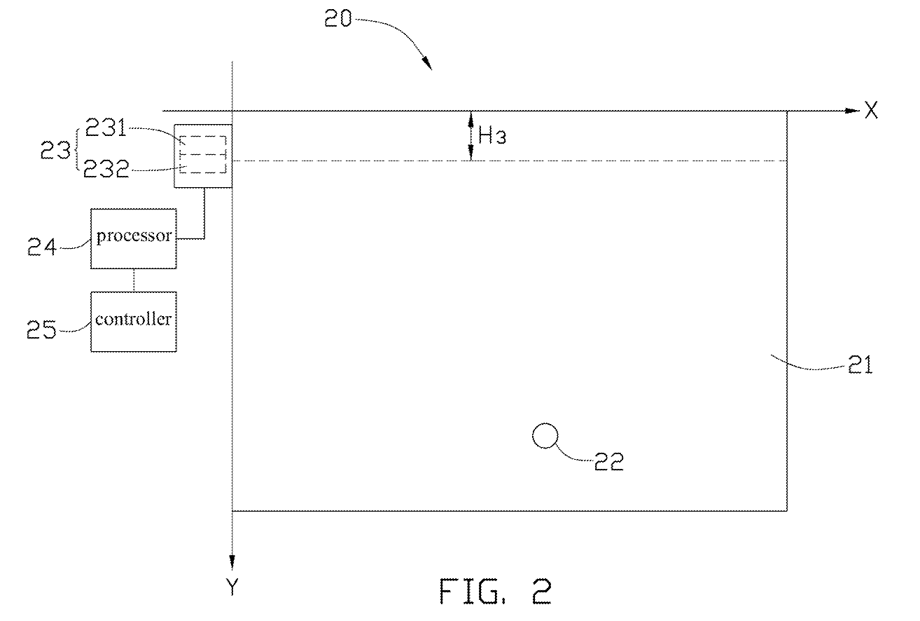

As shown in FIG. 2, a second embodiment of an optical touch system 20 includes a display panel 21, an IR touch pen 22, a time and image sensor 23, a processor 24, and a controller 25. Then time and image sensor 23 includes a time recorder 231 and an image sensor 232.

The optical touch system 20 and the optical touch system 10 differ in that the time and image sensor 23 may be place elsewhere along a side of the display panel 11 and an offset distance H₃ is then included in the calculations when obtaining coordinates of a touch

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An optical touch system, comprising:
an infrared touch pen which includes a pressure sensor and an illuminator electrically connected with the pressure sensor, while the pressure sensor senses a pressure and then the pressure sensor drives the illuminator to emit an infrared beam;
a display panel configured for displaying different images in response to the touch of the infrared touch pen;
an image sensor located adjacent to the display panel and configured to receive the infrared beam emitted by the infrared touch pen;
a time recorder configured for recording a first time at the beginning of an infrared emission event by the infrared touch pen and a second time when the image sensor receives the infrared emission of the same emission event; and
a processor connected with the image sensor and the time recorder and configured for computing a distance between the touch of the infrared touch pen and the image sensor and the coordinates of the touch of the infrared touch pen, wherein, the distance between the touch of the infrared touch pen and the image sensor is described as (t₂−t₁)×v, t₁ is the first time, t₂ is the second time, and v is the light velocity; the coordinates of the touch of the infrared touch pen is determined by the relations of the sides and the angles of a triangle.

2. The optical touch system as described in claim 1, wherein the display panel is rectangle shaped, and the image sensor is located on a corner of the display panel.

3. The optical touch system as described in claim 1, wherein the display panel is rectangle shaped, and the image sensor is located along a side of the display panel.

4. The optical touch system as described in claim 1, wherein the image sensor is one of a charge coupled device and a complementary metal oxide semiconductor.

5. The optical touch system as described in claim 1, wherein the optical touch system further comprises a controller configured to execute whatever command or commands are associated with the touch of the infrared touch pen.

6. The optical touch system as described in claim 2, wherein the coordinates of the touch of the infrared touch pen is determined by using the right-angle side and the sloped edge in a right triangle.

7. An optical touch system, comprising:
an infrared touch pen including a pressure sensor and an illuminator electrically connected with the pressure sensor, the pressure sensor being configured to sense a pressure applied on the infrared touch pen, and the pressure sensor being configured to emit an infrared beam in response to the sensing of the pressure;
a display panel configured to display different images in response to the touch of the infrared touch pen;
an image sensor configured to receive the infrared beam and generate an image signal, the coordinates of the image sensor being predetermined;
a time recorder configured to record a first time at the beginning of an infrared emission event by the infrared touch pen and a second time when the image sensor receives the infrared emission of the same emission event; and
a processor connected with the image sensor and the time recorder, the processor being configured to calculate a distance between the touch of the infrared touch pen and the image sensor and the coordinates of the touch of the infrared touch pen, wherein, the distance between the touch of the infrared touch pen and the image sensor is described as (t₂−t₁)×v, t₁, is the first time, t₂ is the second time, and v is the light velocity; the coordinates of the touch of the infrared touch pen is determined according to the image signal outputted by the image sensor.

8. The optical touch system as described in claim 7, wherein the display panel is rectangle shaped, and the image sensor is located on a corner of the display panel.

9. The optical touch system as described in claim 7, wherein the display panel is rectangle shaped, and the image sensor is located along a side of the display panel.

10. The optical touch system as described in claim 7, wherein the image sensor is one of a charge coupled device and a complementary metal oxide semiconductor.

11. The optical touch system as described in claim 7, further comprising a controller electrically connected with the processor and configured to execute commands associated with the touch of the infrared touch pen.
